(19) United States
(12) Patent Application Publication
(10) Pub. No.: US 2025/0326400 A1
(43) Pub. Date: Oct. 23, 2025

(54) Vehicle Control Apparatus and Method Thereof

(71) Applicants: Hyundai Motor Company, Seoul (KR); Kia Corporation, Seoul (KR)

(72) Inventor: Jin Kwon Kim, Hwaseong-Si (KR)

(21) Appl. No.: 18/939,627

(22) Filed: Nov. 7, 2024

(30) Foreign Application Priority Data
Apr. 17, 2024 (KR) 10-2024-0051532

(51) Int. Cl. B60W 50/14; B60K 35/28; B60W 30/18; B60W 60/00

(52) U.S. Cl. CPC B60W 50/14; B60K 35/28; B60W 30/18163; B60W 60/0015; B60K 2360/11; B60K 2360/1468; B60K 2360/171; B60K 2360/1868; B60W 2050/146; B60W 2554/4042; B60W 2554/802

(57) ABSTRACT

An apparatus may comprise a memory storing at least one instruction, and a processor, and the memory, wherein the at least one instruction is configured to, when executed by the processor, cause the apparatus to obtain, based on sensing information received from a sensor, information about at least one other vehicle traveling in a second lane adjacent to a first lane in which the vehicle is travelling, determine, based on the information and driving information of the vehicle, a front safety distance for each of the at least one other vehicle and a rear safety distance for each of the at least one other vehicle, determine at least one candidate area in the second lane for a lane change, wherein the at least one candidate area excludes areas within the front safety distance and the rear safety distance, and display, via a display, the at least one candidate area.

### CROSS-REFERENCE TO RELATED APPLICATION

This application claims the benefit of priority to Korean Patent Application No. 10-2024-0051532, filed in the Korean Intellectual Property Office on Apr. 17, 2024, the entire contents of which are incorporated herein by reference.

### TECHNICAL FIELD

The present disclosure relates to a vehicle control apparatus and a method thereof, and more particularly, relates to technologies for a lane change.

### BACKGROUND

The matters described in this Background section are only for enhancement of understanding of the background of the disclosure, and should not be taken as acknowledgement that they correspond to prior art already known to those skilled in the art.

As an autonomous driving control technology and/or a semi-autonomous driving control (or cruise driving) technology are/is developed, a stable driving technology for a host vehicle may gradually become more sophisticated. For example, to make a lane change while performing driving control for the host vehicle, a vehicle control apparatus (or system) safely and quickly should perform lane change control with regard to behaviors of other vehicles in an adjacent lane for the lane change.

Meanwhile, various devices (e.g., a center fascia, a head-up display (HUD), a speaker, and the like) for providing a user with information about a driving environment may be loaded into the vehicle. For example, if performing lane change control for the vehicle, the vehicle control apparatus may visually provide the user with information about a direction for making a lane change or a direction in which it is possible to make a lane change.

Furthermore, a device (e.g., a multi-function switch or a turn signal switch) capable of receiving an input (e.g., a turn signal input) about a lane change from the user may be loaded into the vehicle. For example, as the user applies certain pressure to one end of a device disposed in an area adjacent to the steering wheel of the vehicle upward or downward, the vehicle control apparatus may provide a turn signal input corresponding to a right turn or a left turn.

However, because the above-mentioned vehicle control apparatus displays only whether it is possible to make a lane change in real time, it may be somewhat difficult to identify a target area intended by the user among a plurality of candidate areas capable of making the lane change.

### SUMMARY

According to the present disclosure, an apparatus for controlling autonomous driving of a vehicle, the apparatus may comprise a sensor, a display, a memory storing at least one instruction, and a processor operatively coupled to the sensor, the display, and the memory, wherein the at least one instruction is configured to, when executed by the processor, cause the apparatus to obtain, based on sensing information received from the sensor, information about at least one other vehicle which is traveling in a second lane adjacent to a first lane in which the vehicle is travelling, determine, based on the information about the at least one other vehicle and driving information of the vehicle, a front safety distance for each of the at least one other vehicle and a rear safety distance for each of the at least one other vehicle, determine at least one candidate area in the second lane for a lane change, wherein the at least one candidate area excludes areas within the front safety distance and the rear safety distance, and display, via the display, the at least one candidate area.

The apparatus, wherein the at least one instruction is configured to, when executed by the processor, cause the apparatus to determine, based on sensing information received from the sensor, at least one characteristic of the at least one other vehicle, wherein the at least one characteristic may comprise at least one of a speed of the at least one other vehicle or acceleration of the at least one other vehicle, determine whether the vehicle is able overtake a first other vehicle, among the at least one other vehicle, traveling in front of the vehicle by at least a specified distance within a first time, wherein whether the vehicle is able to overtake the first other vehicle is determined based on a speed of the first other vehicle, acceleration of the first other vehicle, and the driving information of the vehicle, and determine, based on a determination that the vehicle is able to overtake the first other vehicle by the at least the specified distance within the first time, a first front safety distance for the first other vehicle.

The apparatus, wherein the at least one instruction is configured to, when executed by the processor, cause the apparatus to determine, based on a speed of a first other vehicle, acceleration of the first other vehicle, and the driving information of the vehicle, whether the vehicle is able to overtake the first other vehicle, among the at least one other vehicle, traveling in front of the vehicle by at least a specified distance within a first time, determine, based on a determination that the vehicle is unable to overtake the first other vehicle by the at least the specified distance within the first time, not to make the lane change to an area in front of the first other vehicle, and determine that no candidate area for a lane change is available in an area in front of the first other vehicle.

The apparatus, wherein the at least one instruction is configured to, when executed by the processor, cause the apparatus to determine a speed of a second other vehicle, among the at least one other vehicle, traveling behind the vehicle, and determine a second front safety distance for the second other vehicle, wherein the second front safety distance is determined based on the speed of the second other vehicle being greater than a speed of the vehicle, a threshold response time, a margin time, and required deceleration and acceleration for the second other vehicle, and wherein the second front safety distance is a predefined minimum distance to be maintained between the vehicle and the second other vehicle.

The apparatus, wherein the second front safety distance is proportional to the speed of the second other vehicle, the threshold response time, and the margin time, and inversely proportional to the required deceleration and acceleration.

The apparatus, wherein the at least one instruction is configured to, when executed by the processor, cause the apparatus to determine a speed of a second other vehicle, among the at least one other vehicle, traveling behind the vehicle, and determine, based on the speed of the second other vehicle being smaller than a speed of the vehicle, a second front safety distance for the second other vehicle, wherein the second front safety distance is a predefined minimum distance to be maintained between the vehicle and the second other vehicle.

The apparatus, wherein the at least one instruction is configured to, when executed by the processor, cause the apparatus to determine the rear safety distance for each of the at least one other vehicle, based on a speed of the vehicle, a margin time, or a margin distance.

The apparatus, wherein the at least one instruction is configured to, when executed by the processor, cause the apparatus to determine a first rear safety distance of a first other vehicle, among the at least one other vehicle, traveling in front of the vehicle and in the second lane, determine a second front safety distance of a second other vehicle traveling behind the vehicle, and determine an area between the first other vehicle and the second other vehicle as the at least one candidate area, wherein the determined area excludes areas within the first rear safety distance and the second front safety distance.

The apparatus, wherein the at least one instruction is configured to, when executed by the processor, cause the apparatus to determine a first front safety distance of a first other vehicle, among the at least one other vehicle, traveling in front of the vehicle and in the second lane, determine a third rear safety distance of a third other vehicle traveling in front of the first other vehicle, and determine an area between the first other vehicle and the third other vehicle as the at least one candidate area, wherein the determined area excludes areas within the first front safety distance and the third rear safety distance.

The apparatus may further comprise an input device, wherein the at least one instruction is configured to, when executed by the processor, cause the apparatus to display, via the display, a first graphic user interface (GUI) and a second GUI based on a first form, wherein the first GUI is associated with a first candidate area among the at least one candidate area and the second GUI is associated with a second candidate area among the at least one candidate area, and based on receiving, via the input device, a user input about the lane change to the second lane during a first period, display, based on a second form different from the first form, the first GUI and display, based on the first form, the second GUI, during a second period, after the first period elapses, display, based on the first form, the first GUI, and display, based on the second form, the second GUI, and during a third period, after the second period elapses, display, based on the second form, the first GUI, and display, based on the first form, the second GUI.

An apparatus for controlling autonomous driving of a vehicle, the apparatus may comprise a sensor, a display, a memory storing at least one instruction, and a processor operatively coupled to the sensor, the display, and the memory, wherein the at least one instruction is configured to, when executed by the processor, cause the apparatus to obtain, based on sensing information received from the sensor, information about at least one other vehicle which is traveling in a second lane adjacent to a first lane in which the vehicle is travelling, determine, based on the information about the at least one other vehicle and driving information of the vehicle, a front safety distance for each of the at least one other vehicle and a rear safety distance for each of the at least one other vehicle, determine at least one candidate area in the second lane for a lane change, wherein the at least one candidate area excludes areas within the front safety distance and the rear safety distance, and display, via the display, the at least one candidate area.

The apparatus, wherein the at least one instruction is configured to, when executed by the processor, cause the apparatus to control the vehicle to move into an area, among the at least one candidate area, to make the lane change, wherein the area to make the lane change corresponds to a GUI displayed in the second form at a time point the user input.

The apparatus, wherein the at least one instruction is configured to, when executed by the processor, cause the apparatus to determine, based on a user input, a target area, among the at least one candidate area, for the lane change, and display, via the display, guide information about one point of the target area, wherein the one point is expected to be reached based on the vehicle making the lane change.

The apparatus, wherein the at least one instruction is configured to, when executed by the processor, cause the apparatus to determine, based on a user input, a target area, among the at least one candidate area, for the lane change, control the vehicle to move into the target area for the lane change, and decrease, based on the target area decreasing in size while controlling the vehicle to move into the target area, a heading of the vehicle and perform biased driving control toward the second lane.

The apparatus, wherein the at least one instruction is configured to, when executed by the processor, cause the apparatus to perform, based on the target area being continuously reduced or maintained in size during a predefined threshold time, return control causing the vehicle to return to the first lane.

The apparatus, wherein the at least one instruction is configured to, when executed by the processor, cause the apparatus to control, based on the target area increasing in size during a predefined threshold time, the vehicle to enter the target area to complete the lane change.

According to the present disclosure, a method performed by an apparatus for controlling autonomous driving of a vehicle, the method may comprise obtaining, based on sensing information received from a sensor, information about at least one other vehicle which is traveling in a second lane adjacent to a first lane in which the vehicle is travelling, determining, based on the information about the at least one other vehicle and driving information of the vehicle, a front safety distance for each of the at least one other vehicle and a rear safety distance for each of the at least one other vehicle, determining at least one candidate area in the second lane for a lane change, wherein the at least one candidate area excludes areas within the front safety distance and the rear safety distance, and displaying, via a display, the at least one candidate area.

The method may further comprise determining, based on sensing information received from the sensor, at least one characteristic of the at least one other vehicle, wherein the at least one characteristic may comprise at least one of a speed of the at least one other vehicle or acceleration of the at least one other vehicle, determining whether the vehicle is able to overtake a first other vehicle, among the at least one other vehicle, traveling in front of the vehicle by at least a specified distance within a first time, wherein whether the vehicle is able to overtake the first other vehicle is determined based on a speed of the first other vehicle, acceleration of the first other vehicle, and the driving information of the vehicle, and determining, based on a determination that the vehicle is able to overtake the first other vehicle by the at least the specified distance within the first time, a first front safety distance for the first other vehicle.

The method may further comprise determining, based on a speed of a first other vehicle, acceleration of the first other vehicle, and the driving information of the vehicle, whether the vehicle is able to overtake the first other vehicle, among the at least one other vehicle, traveling in front of the vehicle by at least a specified distance within a first time, determining, based on a determination that the vehicle is unable to overtake the first other vehicle by the at least the specified distance within the first time, not to make the lane change to an area in front of the first other vehicle, and determining that no candidate area for a lane change is available in an area in front of the first other vehicle.

The method may further comprise determining a speed of a second other vehicle, among the at least one other vehicle, traveling behind the vehicle, and determining a second front safety distance for the second other vehicle, wherein the second front safety distance is determined based on the speed of the second other vehicle being great than a speed of the vehicle, a threshold response time, a margin time, and required deceleration and acceleration for the second other vehicle, and wherein the second front safety distance is a predefined minimum distance to be maintained between the vehicle and the second other vehicle.

The method may further comprise determining a speed of a second other vehicle, among the at least one other vehicle, traveling behind the vehicle, and determining, based on the speed of the second other vehicle being smaller than a speed of the vehicle, a second front safety distance for the second other vehicle, wherein the second front safety distance is a predefined minimum distance to be maintained between the vehicle and the second other vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus according to an example of the present disclosure;

FIG. 2 shows an example of an operation of identifying at least one candidate area in a vehicle control apparatus according to an example of the present disclosure;

FIG. 3 shows an example of an operation of identifying a front safety distance of a preceding vehicle in a vehicle control apparatus according to an example of the present disclosure;

FIG. 4 shows an example of an operation of identifying a front safety distance of a following vehicle in a vehicle control apparatus according to an example of the present disclosure;

FIG. 5 shows an example of an operation of identifying a rear safety distance of each of a preceding vehicle and a following vehicle in a vehicle control apparatus according to an example of the present disclosure;

FIG. 6A shows an example of an input device according to an example of the present disclosure;

FIG. 6B shows an example of an operation of displaying at least one candidate area on a display in a vehicle control apparatus according to an example of the present disclosure;

FIG. 6C shows an example of an operation of displaying at least one candidate area on a display in a vehicle control apparatus according to an example of the present disclosure;

FIG. 6D shows an example of an operation of displaying at least one candidate area on a display in a vehicle control apparatus according to an example of the present disclosure;

FIG. 7 shows an example of an operation of displaying at least one candidate area on a display in a vehicle control apparatus according to an example of the present disclosure;

FIG. 8 shows an example of an operation of making a lane change in a vehicle control apparatus according to an example of the present disclosure;

FIG. 9 shows an example of a vehicle control method according to an example of the present disclosure; and

FIG. 10 shows an example of a computing system about a vehicle control apparatus or a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

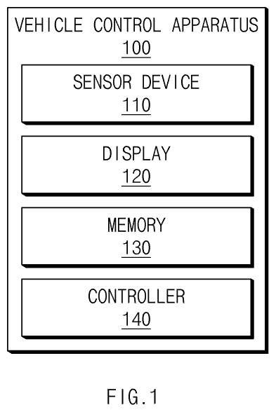

Hereinafter, examples of the present disclosure will be described in detail with reference to FIGS. 1 to 10.

FIG. 1 shows an example of components of a vehicle control apparatus according to an example of the present disclosure.

According to an example, a vehicle control apparatus 100 may include a sensor 110 (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), a display 120, a memory 130, and/or a controller 140. The components of the vehicle control apparatus 100, which are shown in FIG. 1, are examples of the present disclosure are not limited thereto. For example, the vehicle control apparatus 100 may further include components (e.g., at least one of a communication device, an interface, or a notification device, or any combination thereof) which are not shown in FIG. 1.

According to an example, the sensor 110 may obtain (or identify) various pieces of information used to control driving of a host vehicle.

For example, the sensor 110 may include at least one sensor including at least one of a camera, radio detection and ranging (radar), or light detection and ranging (LiDAR), or any combination thereof.

For example, the sensor 110 may obtain information about an external object (e.g., at least one of a person, another vehicle, a building, or a structure, or any combination thereof), using the at least one sensor.

For example, the sensor 110 may obtain information about a driving environment (e.g., lanes (e.g., a number and orientation of lanes), traffic lights (e.g., location and status of traffic lights), signs (e.g., location and status of road signs), road conditions (e.g., potholes, bumps, road texture), traffic flow (e.g., traffic density, speeds, patterns), obstacles and hazard information (e.g., construction zones, debris, pedestrians), location of crosswalks and pedestrian paths, layouts of intersections, or roadside features (e.g., barriers, guardrails, sidewalks, edges), etc.) of the host vehicle. As an example, the sensor 110 may obtain information about at least one of a driving speed of the host vehicle, acceleration of the host vehicle, or a driving direction of the host vehicle, or any combination thereof.

For example, the sensor 110 may obtain information about a lane in which the host vehicle is traveling and information about an adjacent lane adjacent to the lane of the host vehicle. As an example, the adjacent lane may include a left lane and/or a right lane of the lane. The sensor 110 may obtain, for example, information about a line of the lane and lines of the left lane and the right lane. The controller 140 may identify, for example, a range (or an area) of the adjacent lane using the information about the line. The controller 140 may identify, for example, a distance from the host vehicle to the adjacent lane, a width of the adjacent lane, a space for making a lane change to the adjacent lane, or the like.

For example, the sensor 110 may obtain information about whether there is at least one other vehicle and/or a driving state of the at least one other vehicle (e.g., at least one of a driving speed of the at least one other vehicle, acceleration of the at least one other vehicle, a driving direction of the at least one other vehicle, a separation distance from the host vehicle, a separation distance between the at least one other vehicle, whether the at least one other vehicle is stopped, or specifications (e.g., a length and a width) of the at least one other vehicle, or any combination thereof).

As an example, the sensor 110 may obtain a driving speed of each of the at least one other vehicle which is traveling in a lane (e.g., a left lane and/or a right lane) next to the lane in which the host vehicle is traveling. The sensor 110 may obtain, for example, a separation distance between the at least one other vehicle.

According to an example, the display 120 may be mounted on one area in the host vehicle and may include at least one output device for providing visual and/or audible content.

For example, the display 120 may display at least one candidate area for the host vehicle to make a lane change to the adjacent lane.

According to an example, the memory 130 may store a command or data. For example, the memory 130 may store one or more instructions, if executed by the controller 140, causing the vehicle control apparatus 100 to perform various operations.

For example, the memory 130 and the controller 140 may be implemented as one chipset. The controller 140 may include at least one of a communication processor or a modem.

For example, the memory 130 may store various pieces of information associated with the vehicle control apparatus 100. As an example, the memory 130 may store information about an operation history of the controller 140. As an example, the memory 130 may store information associated with states and/or operations of components (e.g., at least one of an engine control unit (ECU), the sensor 110, the display 120, or the controller 140, or any combination thereof) of the host vehicle.

For example, the memory 130 may include a plurality of different types of storage devices (e.g., a random-access memory (RAM), an embedded multi-media card (eMMC), a data scratch pad RAM (DSPR), a data local memory unit (DLMU), a local memory unit (LMU), or a default application memory (DAM), etc.). For example, the memory 130 may include at least one of a random-access memory (RAM) or an embedded multi-media card (eMMC), or any combination thereof.

As an example, the RAM may temporarily store data (e.g., driving data) about an operation of the vehicle control apparatus 100 and/or the host vehicle which is a control target of the vehicle control apparatus 100. The RAM may include, for example, at least one buffer. The vehicle control apparatus 100 may store, for example, at least one node divided by dividing pieces of data collected (or identified) while performing autonomous driving control for the host vehicle by a unit time in the RAM.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

As an example, the eMMC may include a built-in multimedia card. The eMMC may store, for example, data for a longer duration than the RAM. The eMMC may be implemented as, for example, a separate memory chip independent of the RAM.

According to an example, the controller 140 may be operatively connected with the memory 130. For example, the controller 140 may control an operation of the memory 130.

For example, the controller 140 may obtain information about the at least one other vehicle which is traveling in the adjacent lane adjacent to the lane of the host vehicle, using the sensor 110.

For example, the controller 140 may identify the at least one other vehicle which is traveling in the adjacent lane adjacent to the lane (e.g., a left lane and/or a right lane of the lane), using the sensor 110.

As an example, the controller 140 may obtain at least one of a driving speed of each of at least one preceding vehicle which is traveling in front of the host vehicle and at least one following vehicle which is traveling behind the host vehicle, among the at least one other vehicle, driving acceleration of each of the at least one preceding vehicle and the at least one following vehicle, a driving direction of each of the at least one preceding vehicle and the at least one following vehicle, or a heading of each of the at least one preceding vehicle and the at least one following vehicle, or any combination thereof, using the sensor 110.

For example, the controller 140 may identify a front safety distance and a rear safety distance for each of the at least one other vehicle, based on the information about the at least one other vehicle and driving information of the host vehicle. A safety distance may refer to the minimum distance that a self-driving vehicle maintains from the vehicle in front, other road users, or obstacles to avoid collisions and ensure safe driving. This distance may allow the autonomous vehicle sufficient time to react to sudden changes in traffic conditions, such as braking, lane changes, or obstacles on the road. The safety distance in autonomous driving may be affected by various factors. For examples, speed of the vehicle (as a vehicle's speed increases, the required safety distance also increases because it takes more time and distance to stop safely in case of sudden braking or unexpected obstacles), reaction time (autonomous vehicles may require time to process sensor data (from cameras, radar, LiDAR, etc.) and make decisions. The safety distance accounts for this reaction time), weather and road Conditions (in adverse conditions like rain, snow, or ice, braking distances increase, so the autonomous system may adjust the safety distance accordingly to maintain control and prevent skidding or sliding), traffic flow (in congested or stop-and-go traffic, the safety distance may be reduced, but the autonomous system may constantly monitor nearby vehicles and adjust accordingly to maintain safe margins), or regulations and standards (legal regulations may mandate a minimum safety distance that autonomous vehicles must observe, depending on the country or region).

As an example, the front safety distance may include a forward distance from a first point (e.g., one point of a front bumper) of the other vehicle. As an example, the rear safety distance may include a backward distance from a second point (e.g., one point of a rear bumper) of the other vehicle.

A safety distance may be used, for example, following distance (the distance between the autonomous vehicle and the vehicle in front). The vehicle may adjust this distance dynamically depending on the driving speed. The safety distance may be used, for example, overtaking. When overtaking another vehicle, an autonomous vehicle may determine a safe distance for merging back into the lane, ensuring it leaves enough space between the overtaken vehicle and itself. The safety distance may be used, for example, stopping. If an object or pedestrian suddenly appears in front of the vehicle, the safety distance ensures the autonomous vehicle may stop or take evasive action without causing an accident.

For example, the controller 140 may determine whether it is possible for the host vehicle to overtake a first other vehicle which is traveling in front of the host vehicle among the at least one other vehicle, using a driving speed of the first other vehicle, acceleration of the first other vehicle, and driving information of the host vehicle, and may identify a first front safety distance of the first other vehicle using the determined result.

As an example, the controller 140 may determine whether it is possible for the host vehicle to overtake the first other vehicle by a specified distance (e.g., 10 m) or more within a first time (e.g., 5 seconds), using the driving speed of the first other vehicle, the acceleration of the at least one other vehicle, and the driving information of the host vehicle. The controller 140 may determine, for example, whether it is possible for the host vehicle to overtake the first other vehicle, based on Equation 1 below.

$${v}_{LF 1} {T}_{max \_ waiting} + \frac{1}{2} {a}_{LF 1} {T}_{max \_ waiting}^{2} < {v}_{ego} {T}_{max \_ waiting} + \frac{1}{2} {a}_{ego} {T}_{max \_ waiting}^{2} + margin \qquad [ Equation 1 ]$$

As an example, v_{LF1} may be the driving speed of the first other vehicle, T_{max_waiting} may be the first time (e.g., 5 seconds), a_{LF1} may be the acceleration of the first other vehicle, v_{ego} may be driving speed of the host vehicle, and a_{ego} may be the acceleration of the host vehicle. For example, margin may be the specified distance (e.g., 10 m).

For example, if a value of a right-hand side is greater than a value of a left-hand side like Equation 1 above, the controller 140 may determine that it is possible for the host vehicle to overtake the first other vehicle by the specified distance or more within the first time. If it is determined that it is possible for the host vehicle to overtake the first other vehicle by the specified distance or more within the first time, the controller 140 may identify a predefined preceding vehicle front safety distance (e.g., 10 m) as the first front safety distance for the first other vehicle.

For example, if the value of the left-hand side is greater than the value of the right-hand side unlike Equation 1 above, the controller 140 may determine that it is impossible for the host vehicle to overtake the first other vehicle by the specified distance or more within the first time. In this case, the controller 140 may identify the first front safety distance for the first other vehicle as infinity. In other words, after determining whether it is impossible for the host vehicle to overtake the first other vehicle, because the first front safety distance of the first other vehicle is infinity, the controller 140 may determine that it is impossible for the host vehicle to make a lane change to an area in front of the first other vehicle. Thus, the controller 140 may identify that there is no at least one candidate area in the area in front of the first other vehicle.

For example, the controller 140 may obtain a driving speed of a second other vehicle which is traveling behind the host vehicle among the at least one other vehicle, acceleration of the second other vehicle, and driving information of the host vehicle and may identify a second front safety distance of the second other vehicle, using the result of determining whether the driving speed of the host vehicle is greater than the driving speed of the second other vehicle.

As an example, if the driving speed of the second other vehicle is greater than the driving speed of the host vehicle (or if the second other vehicle is traveling to be greater than the host vehicle), the controller 140 may identify the second front safety distance for the second other vehicle, using the driving speed of the second other vehicle, the driving speed of the host vehicle, a threshold response time, a margin time, and required deceleration and acceleration for the second other vehicle. The controller 140 may identify, for example, the second front safety distance based on Equation 2 below.

$${S}_{frft \_ mrgn}^{LR 1} = ( {v}_{LR 1} - {v}_{ego} ) \times {t}_{B} + \frac{{( {v}_{LR 1} - {v}_{ego} )}^{2}}{2 a} + {v}_{ego} \times {t}_{G} \qquad [ Equation 2 ]$$

As an example, the value of the left-hand side may be the second front safety distance of the second other vehicle. As an example, V_{LR1} may be the driving speed of the second other vehicle, v_{ego} may be the driving speed of the host vehicle, tp may be the threshold response time (e.g., 0.4 seconds), and t_{G} may be the margin time (e.g., 1 second). As an example, a may be the required deceleration and acceleration (e.g., 3 m/s²). The controller 140 may identify, for example, the second front safety distance corresponding to the second other vehicle, based on Equation 2 described above. For example, the second front safety distance may be identified as being proportional to the driving speed of the second other vehicle, the threshold response time, and the margin time and being inversely proportional to the required deceleration and acceleration.

As an example, if the driving speed of the second other vehicle is smaller than the driving speed of the host vehicle (or if the second other vehicle is traveling to be smaller than the host vehicle), the controller 140 may identify a predefined following vehicle front safety distance (e.g., 10 m) as the second front safety distance for the second other vehicle.

For example, the controller 140 may identify a rear safety distance for each of the at least one other vehicle, using the driving speed of the host vehicle, the margin time, or a margin distance, or any combination thereof. The controller 140 may identify, for example, the rear safety distance based on Equation 3 below.

$${v}_{ego} \times {t}_{G} + margin \qquad [ Equation 3 ]$$

As an example, v_{ego} may be the driving speed of the host vehicle, t_{B} may be the margin time (e.g., 1 second), and margin may be the margin distance (e.g., 10 m). According to Equation 3 above, the controller 140 may identify the rear safety distance for each of the at least one other vehicle. In other words, the rear safety distance may be identified to be proportional to the driving speed of the host vehicle, regardless of a behavior of the at least one other vehicle.

For example, the controller 140 may identify at least one candidate area in the adjacent lane for a lane change, except for an area including the front safety distance and the rear safety distance.

As an example, the controller 140 may identify a candidate area between a preceding vehicle and a following vehicle among the at least one other vehicle. As an example, the controller 140 may identify a first rear safety distance of the first other vehicle which is traveling in front of the host vehicle on the adjacent lane and a second front safety distance of the second other vehicle which is traveling behind the host vehicle. The controller 140 may identify, for example, an area between the first other vehicle and the second other vehicle, except for areas respectively corresponding to the first rear safety distance and the second front safety distance, in the adjacent lane as the at least one candidate area.

As an example, the controller 140 may identify a candidate area between preceding vehicles among the at least one other vehicle. As an example, the controller 140 may identify a first front safety distance of the first other vehicle which is traveling in front of the host vehicle on the adjacent lane and a third rear safety distance of a third other vehicle which is traveling in front of the first other vehicle. The controller 140 may identify, for example, an area between the first other vehicle and the third other vehicle, except for areas respectively corresponding to the first rear safety distance and the third rear safety distance, in the adjacent lane as the at least one candidate area.

As an example, the controller 140 may identify a candidate area between following vehicles among the at least one other vehicle. As an example, the controller 140 may identify a second rear safety distance of the second other vehicle which is traveling behind the host vehicle on the adjacent lane and a fourth front safety distance of a fourth other vehicle which is traveling behind the second other vehicle. The controller 140 may identify, for example, an area between the second other vehicle and the fourth other vehicle, except for areas respectively corresponding to the second front safety distance and the fourth front safety distance, in the adjacent lane as the at least one candidate area.

For example, the controller 140 may display the at least one candidate area based on various forms, using the display 120. The form may refer to one of, for example, a display color of a graphic user interface (GUI) corresponding to the at least one candidate area, a display shape of the GUI, a display font of the GUI, or a display size of the GUI, or any combination thereof.

As an example, if the at least one candidate area is identified, the controller 140 may first display a first GUI and a second GUI respectively corresponding to a first candidate area and a second candidate area among the at least one candidate area based on a first form, using the display 120. The first form may be, for example, a green rectangle, but examples of the present disclosure are not limited thereto.

As an example, while displaying the GUI based on the first form, if receiving a user input about a lane change to an adjacent lane via an input device (not shown), the controller 140 may change a display form.

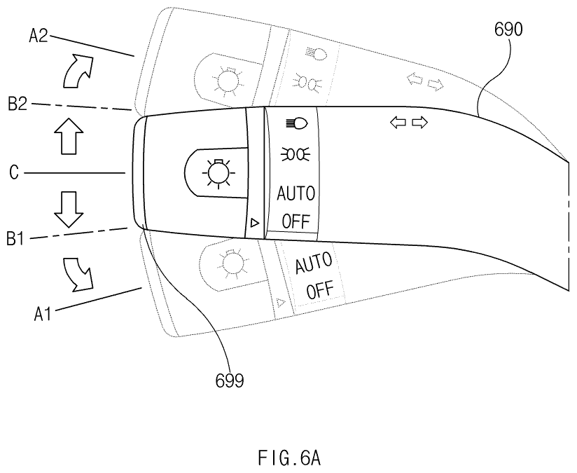

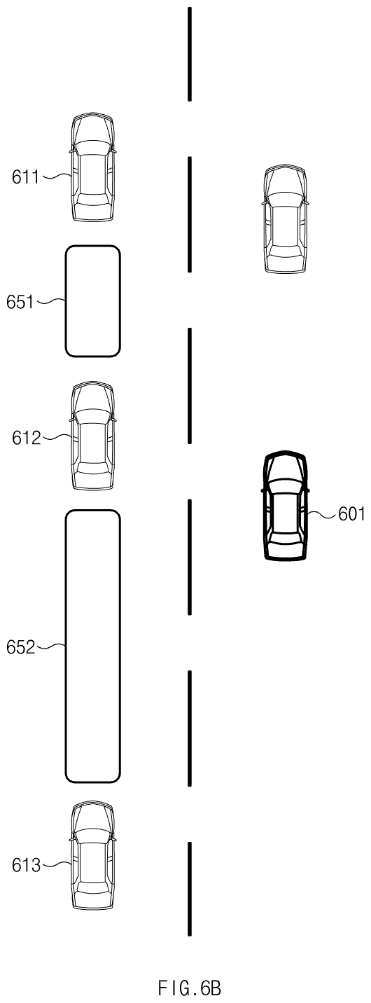

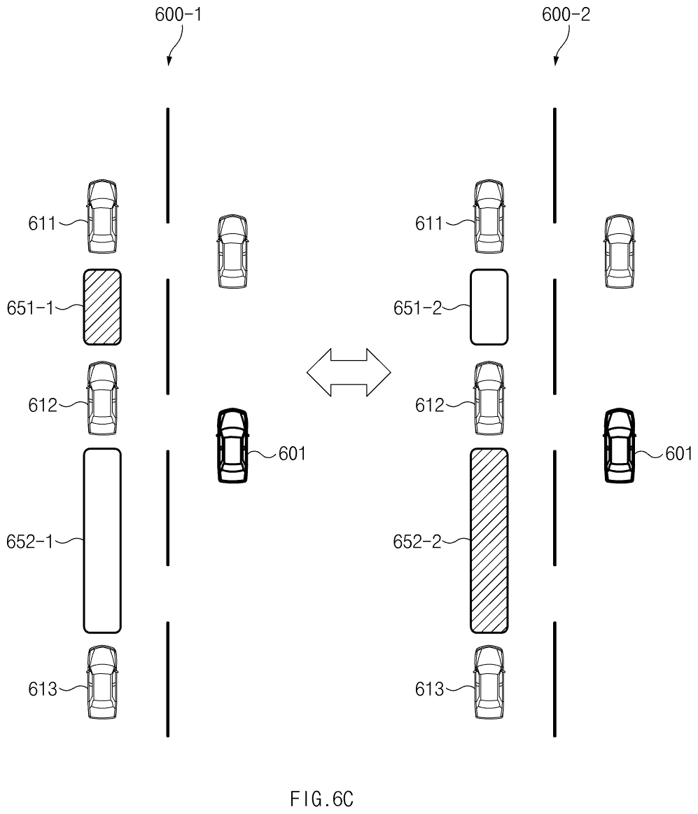

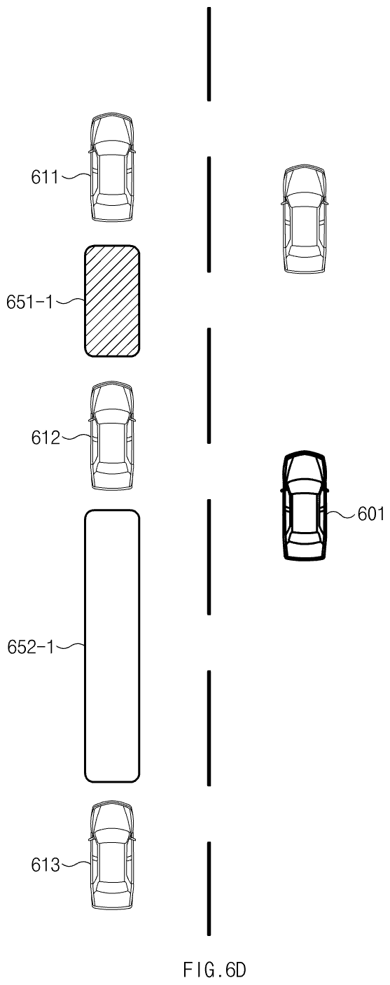

The input device may be implemented with details for FIG. 6A, which will be described below. For example, the input device may include a turn signal switch (or a multi-function switch) disposed adjacent to a steering wheel. One end of the input device may be located at an initial neutral position (e.g., position C in FIG. 6A). If a user moves the one end of the input device upward (or downward), the one end of the input device may be fixed upward (or downward). The state in which the one end of the input device is fixed may be defined as a latch position (e.g., positions A1 and A2 in FIG. 6A).

The user input may be an input for touching the one end of the input device upward (or downward) based on specified pressure. The specified pressure may be smaller than, for example, pressure used for the one end of the input device to move to the latch position. In other words, the user input may be an input for moving the one end of the input device immediately before the latch position without moving the one end of the input device to the latch position. The state in which the one end of the input device is located by the user input may be defined as a half-turn position (e.g., positions B1 and B2 in FIG. 6A). If the user input is ended, the input device may automatically move to the neutral position again.

As an example, if the user input is received, the controller 140 may display the first GUI based on a second form distinguished from the first form and may display the second GUI based on the first form, during a first period (e.g., 0.4 seconds), while the user input is maintained. The second form may be, for example, a rectangle of a color (e.g., orange) distinguished from the first form, but examples of the present disclosure are not limited thereto.

As an example, if the first period elapses while the user input is maintained, the controller 140 may display the first GUI based on the first form and may display the second GUI based on the second form, during a subsequent second period (e.g., 0.4 seconds). Thereafter, if the second period elapses while the user input is maintained, the controller 140 may display the first GUI based on the second form and may display the second GUI based on the first form, during a third period (e.g., 0.4 seconds). In other words, the controller 140 may alternately display the first GUI and the second GUI in the first form and the second form. If the period elapses, the controller 140 may change the first GUI and the second GUI to different forms and may display the first GUI and the second GUI in the different forms.

As an example, if the user input is ended, the controller 140 may identify a GUI displayed in the second form at a time point when the user input is ended among the at least one candidate area. The controller 140 may control, for example, the host vehicle to an area corresponding to the identified GUI, thus making a lane change. In other words, the controller 140 may identify the area corresponding to the GUI identified at the time point when the user input is ended as a lane change area required by the user.

For example, if identifying a target area for a lane change among the at least one candidate area, the controller 140 may further display guide information about the target area.

As an example, the controller 140 may identify the target area for the lane change among the at least one candidate area, based on the user input.

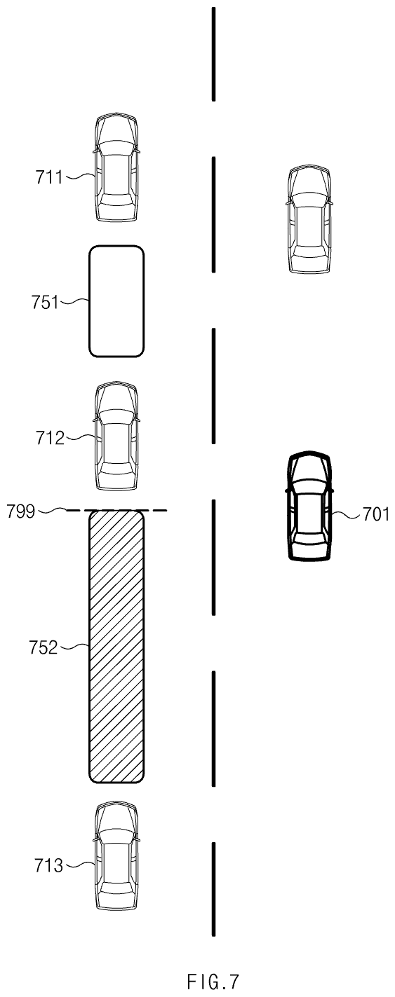

As an example, the controller 140 may display guide information about one point of the target area expected to be reached if the host vehicle makes a lane change, using the display 120. The guide information may include, for example, a GUI 799 of FIG. 7.

For example, as the target area changes in size while making the lane change to the target area, the controller 140 may stop making the lane change or may continue making the lane change.

As an example, the controller 140 may identify the target area for the lane change among the at least one candidate area, based on the user input, and may control the host vehicle to move to the target area for the lane change.

As an example, if the size of the target area is continuously reduced or maintained during a predefined threshold time (e.g., 3 seconds), the controller 140 may perform return control for the ego host to return to the lane.

As an example, if the target area increases in size during the predefined threshold time, the controller 140 may control the host vehicle to enter the target area, thus completing the lane change.

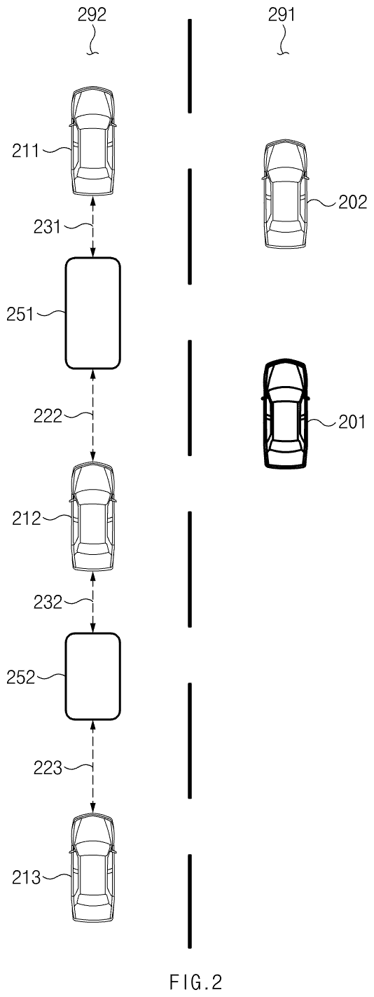

FIG. 2 shows an example of an operation of identifying at least one candidate area in a vehicle control apparatus according to an example of the present disclosure.

According to an example, a vehicle control apparatus (e.g., a vehicle control apparatus 100 of FIG. 1) may identify at least one candidate area (251 and 252) for a lane change of a host vehicle 201 which is traveling in a lane 291.

For example, the vehicle control apparatus may identify a front vehicle 202 present in front of the host vehicle 201 on the lane 291, using a sensor (e.g., a sensor 110 of FIG. 1).

For example, the vehicle control apparatus may identify at least one other vehicle (211, 212, and 213) which is traveling on an adjacent lane 292 adjacent to the lane 291.

For example, the vehicle control apparatus may identify the first other vehicle (or the preceding vehicle) 211 which travels in front of the host vehicle 201 and the second other vehicle (or the following vehicle) 212 and the third other vehicle 213, which travel behind the host vehicle 201.

For example, the vehicle control apparatus may identify a first rear safety distance 231 of the first other vehicle 211, a second front safety distance 222 and a second rear safety distance 232 of the second other vehicle 212, and a third front safety distance 223 of the third other vehicle 213.

As an example, based on the description of FIG. 1 described above, the vehicle control apparatus may identify front and rear safety distances of the preceding vehicle and front and rear safety distances of the following vehicle based on different schemes.

For example, the vehicle control apparatus may identify the first candidate area 251 between the first other vehicle 211 and the second other vehicle 212 and the second candidate area 252 between the second other vehicle 212 and the third other vehicle 213.

As an example, the first candidate area 251 may be one area on the adjacent lane 292, except for an area corresponding to the first rear safety distance 231 of the first other vehicle 211 and the second front safety distance 222 of the second other vehicle 212.

As an example, the second candidate area 252 may be one area on the adjacent lane 292, except for an area corresponding to the second rear safety distance 232 of the second other vehicle 212 and the third front safety distance 223 of the third other vehicle 213.

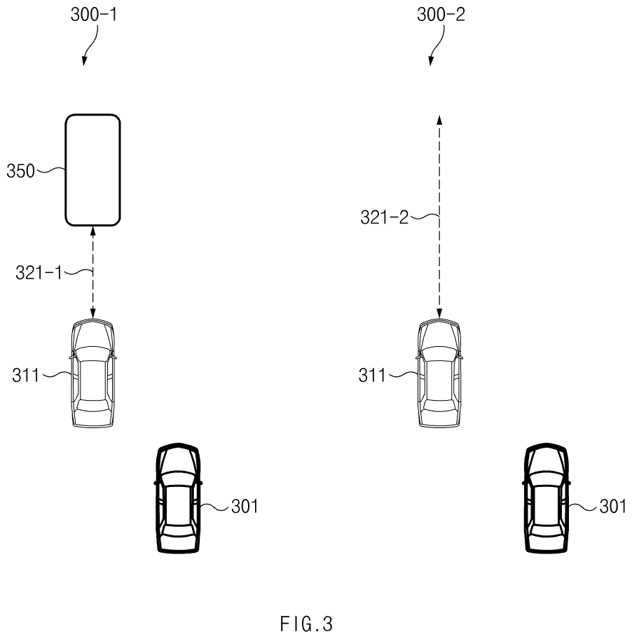

FIG. 3 shows an example of an operation of identifying a front safety distance of a preceding vehicle in a vehicle control apparatus according to an example of the present disclosure. According to an example, a vehicle control apparatus (e.g., a vehicle control apparatus 100 of FIG. 1) may identify at least one other vehicle (e.g., a first other vehicle 311) which is traveling in an adjacent lane adjacent to a lane in which an host vehicle 301 is traveling.

For example, the vehicle control apparatus may determine whether it is possible for the host vehicle 301 to overtake the first other vehicle 311, which is traveling in front of the host vehicle 301, by a specified distance or more within a first time (e.g., 5 seconds), using a driving speed of the first other vehicle 311, acceleration of the first other vehicle 311, and driving information of the host vehicle 301, and may identify a first front safety distance 321-1 of the first other vehicle 311 in a different scheme depending on the determined result.

The example according to reference numeral 300-1 may be, for example, a situation determined that it is possible for the host vehicle 301 to overtake the first other vehicle 311 by the specified distance (e.g., 10 m) or more.

For example, the vehicle control apparatus may identify the first front safety distance 321-1 corresponding to the first other vehicle 311. As an example, if it is determined that it is possible for the host vehicle 301 to overtake the first other vehicle 311 by the specified distance or more within the first time, the vehicle control apparatus may identify a predefined preceding vehicle front safety distance as the first front safety distance 321-1 for the first other vehicle 311. The vehicle control apparatus may identify at least a portion of an area in front of the first front safety distance 321-1 as a candidate area 350 for a lane change.

The example according to reference numeral 300-2 may be, for example, a situation determined that it is impossible for the host vehicle 301 to overtake the first other vehicle 311 by the specified distance (e.g., 10 m) or more within the first time.

For example, if it is expected for the host vehicle 301 not to overtake the first other vehicle 311 within the first time or it is expected for the host vehicle 301 to be spaced apart from the first other vehicle 311 at the specified distance within the first time and not to overtake the first other vehicle 311, the vehicle control apparatus may determine that it is impossible for the host vehicle 301 to make a lane change to the area in front of the first other vehicle 311. Thus, the vehicle control apparatus may identify the first front safety distance 321-2 for the first other vehicle 311 as infinity.

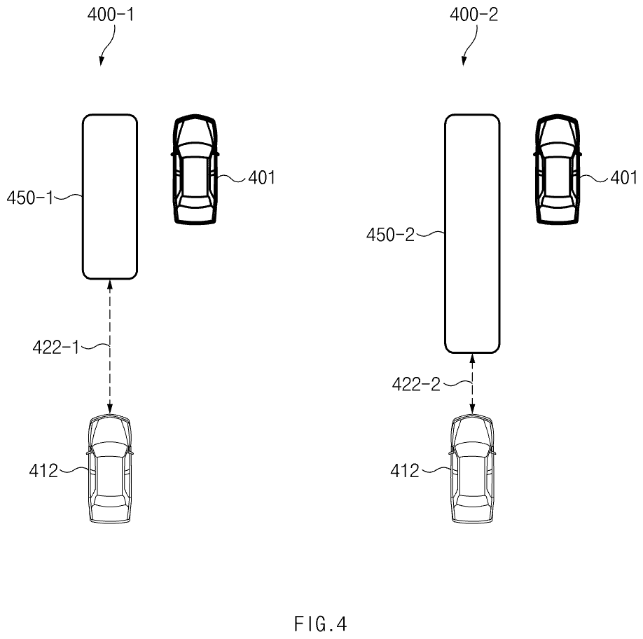

FIG. 4 shows an example of an operation of identifying a front safety distance of a following vehicle in a vehicle control apparatus according to an example of the present disclosure.

According to an example, a vehicle control apparatus (e.g., a vehicle control apparatus 100 of FIG. 1) may identify at least one other vehicle (e.g., a second other vehicle 412) which is traveling in an adjacent lane adjacent to a lane in which a host vehicle 401 is traveling.

For example, the vehicle control apparatus may identify a front safety distance of the second other vehicle 412 in a different scheme, based on whether the driving speed of the second other vehicle 412 which is traveling behind a host vehicle 401 is greater than the driving speed of the host vehicle 401.

The example according to reference numeral 400-1 may be, for example, a situation in which the driving speed of the host vehicle 401 is smaller than the driving speed of the second other vehicle 412.

For example, the vehicle control apparatus may identify a second front safety distance 422-1 corresponding to the second other vehicle 412. As an example, if the driving speed of the second other vehicle 412 is greater than the driving speed of the host vehicle 401, the vehicle control apparatus may identify the second front safety distance 422-1 for the second other vehicle 412, using the driving speed of the second other vehicle 412, the driving speed of the host vehicle 401, a threshold response time, a margin time, and required deceleration and acceleration for the second other vehicle 412. The second front safety distance 422-1 of the second other vehicle 412, which is identified if the driving speed of the second other vehicle 412 is greater than the driving speed of the host vehicle 401, may be identified as being proportional to the driving speed of the second other vehicle 412, the threshold response time, and the margin time and being inversely proportional to the required deceleration and acceleration.

The example according to reference numeral 400-2 may be, for example, a situation in which the driving speed of the host vehicle 401 is greater than the driving speed of the second other vehicle 412.

For example, if the driving speed of the second other vehicle 412 is smaller than the driving speed of the host vehicle 401, the vehicle control apparatus may identify a predefined following vehicle front safety distance (e.g., 10 m) as the second front safety distance 422-2 for the second other vehicle 412.

According to an example, the vehicle control apparatus may identify at least a portion of an area in front of the second front safety distance 422-1 or 422-2 as a candidate area 450-1 or 450-2 for a lane change.

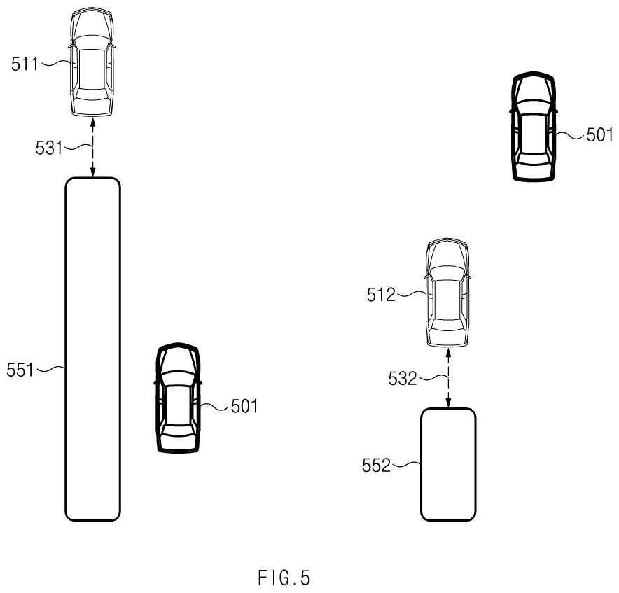

FIG. 5 shows an example of an operation of identifying a rear safety distance of each of a preceding vehicle and a following vehicle in a vehicle control apparatus according to an example of the present disclosure.

According to an example, a vehicle control apparatus (e.g., a vehicle control apparatus 100 of FIG. 1) may identify at least one other vehicle (e.g., a first other vehicle 511 and a second other vehicle 512) which is traveling in an adjacent lane adjacent to a lane in which a host vehicle 501 is traveling.

For example, the vehicle control apparatus may identify a rear safety distance for each of the first other vehicle 511 which is traveling in front of the host vehicle 501 and the second other vehicle 512 is traveling behind the first other vehicle 511.

For example, the vehicle control apparatus may identify a first rear safety distance 531 and a second rear safety distance 532 for the first other vehicle 511 and the second other vehicle 512, using at least one of a driving speed of the host vehicle 501, a margin time, or a margin distance, or any combination thereof.

According to an example, the vehicle control apparatus may identify at least a portion of an area behind the first rear safety distance 531 and the second rear safety distance 532 as a candidate area 551 or 552 for a lane change.

FIG. 6A shows an example of an input device according to an example of the present disclosure.

According to an example, a vehicle control apparatus (e.g., a vehicle control apparatus 100 of FIG. 1) may further include an input device 690. The input device 690 may be defined as, for example, a turn signal switch or a multi-function switch.

For example, if pressure with first intensity is applied to one end 699 of the input device 690 upward or downward, the one end 699 of the input device 690 may be fixed upward or downward. The state in which the one end 699 of the input device 690 is fixed may be defined as a latch position. As an example, for a state (e.g., state A1) in which the one end 699 of the input device 690 is fixed downward, the vehicle control apparatus may continuously operate a turn signal (e.g., a light) for a left turn. As an example, for a state (e.g., state A2) in which the one end 699 of the input device 690 is fixed upward, the vehicle control apparatus may continuously operate a turn signal (e.g., a light) for a right turn.

For example, if pressure with second intensity smaller than the first intensity is applied to the one end 699 of the input device 690 upward or downward, the one end 699 of the input device 690 may move upward or downward. At this time, the pressure is stopped, the one end 699 of the input device 690 may return to a neutral state (e.g., state C) again. A state in which the pressure with the second intensity is maintained and temporarily stopped, after the one end 699 of the input device 690 moves based on the pressure with the second intensity, may be defined as a half-turn position. As an example, for a state (e.g., state B1) in which the one end 699 of the input device 690 moves downward and stops, the vehicle control apparatus may operate the turn signal (e.g., the light) for the left turn during a specified time. As an example, for a state (e.g., state B2) in which the one end 699 of the input device 690 moves upward and stops, the vehicle control apparatus may operate the turn signal (e.g., the light) for the right turn during the specified time.

For example, the vehicle control apparatus may identify at least one candidate area for a lane change and may display a user interface about the at least one candidate area (e.g., a user interface according to FIGS. 6B to 6D) on a display (e.g., a display 120 of FIG. 1).

As an example, if receiving a user input about a lane change to an adjacent lane via the interface while the user interface is displayed, the vehicle control apparatus may change a display method of the user interface.

As an example, if the one end 699 moves to the half-turn position, the vehicle control apparatus may determine that the user input is received. Thereafter, if the one end 699 is maintained as the half-turn position, the vehicle control apparatus may continue changing the display method of the user interface.

FIGS. 6B, 6C, and 6D are conceptual diagrams illustrating an operation of displaying at least one candidate area on a display in a vehicle control apparatus according to an example of the present disclosure.

According to an example, a vehicle control apparatus (e.g., a vehicle control apparatus 100 of FIG. 1) may identify a lane in which a host vehicle 601 is traveling and may identify at least one other vehicle (611, 612, and 613) which is traveling in an adjacent lane adjacent to the lane.

For example, the vehicle control apparatus may identify at least one candidate area (651 and 652) for a lane change, based on a front safety distance and a rear safety distance for each of the at least one other vehicle (611, 612, and 613).

For example, if the at least one candidate area (651 and 652) is identified, the vehicle control apparatus may first display a user interface according to FIG. 6B on a display.

As an example, referring to the user interface according to FIG. 6B, the vehicle control apparatus may display a first GUI 651 corresponding to a first candidate area between the first other vehicle 611 and the second other vehicle 612 and a second GUI 652 corresponding to a second candidate area between the second other vehicle 612 and the third other vehicle 613 in the same display form (e.g., green).

Referring to FIG. 6C, according to an example, if receiving a user input via an input device, the vehicle control apparatus may periodically change a display scheme of the user interface, while the user input is maintained.

Referring to reference numeral 600-1, according to an example, if receiving a user input about a lane change to an adjacent lane via the input device, the vehicle control apparatus may periodically change a display form of a GUI, while the user input is maintained. For example, while the user input is maintained, the vehicle control apparatus may display a 1-1st GUI 651-1 corresponding to a first candidate area in a second form (e.g., orange) distinguished from a first form during a first period and may maintain and display a 2-1st GUI 652-1 corresponding to a second candidate area in the first form which is an initial form.

Referring to reference numeral 600-2, according to an example, after the first period elapses, the vehicle control apparatus may change and display a display form of a 1-2nd GUI 651-2 corresponding to the first candidate area from the second form to the first form again during a second period and may change and display a display form of a 2-2nd GUI 652-2 corresponding to the second candidate area from the first form to the second form.

In other words, while the user input is maintained, the vehicle control apparatus may periodically change a display scheme of a GUI corresponding to each of at least one candidate area.

For example, if a specified time elapses, the vehicle control apparatus may change a user interface to display forms according to reference numerals 600-1 and 600-2.

For example, the vehicle control apparatus may display one GUI in a different display form during one period and may display the remaining GUIs in the same display form (e.g., the first form).

Referring to FIG. 6D, according to an example, the vehicle control apparatus may identify a target area for a lane change based on display forms of respective GUIs at a time point when the user input is ended.

For example, if a user stops the user input to the input device, one end of the input device may return to a neutral position and the vehicle control apparatus may identify that the user input is ended.

For example, if the user input is ended, the vehicle control apparatus may control the host vehicle 601 to an area corresponding to the GUI displayed in the second form at the time point when the user input is ended among the at least one candidate area, thus making a lane change.

According to FIG. 6D, for example, the GUI displayed in the second form at the time point when the user input is ended may be the 1-1st GUI 651-1. Thus, the vehicle control apparatus may identify a first candidate area corresponding to the 1-1st GUI 651-1 as a target area and may control the host vehicle 601 to move to the first candidate area to complete the lane change.

FIG. 7 shows an example of an operation of displaying at least one candidate area on a display in a vehicle control apparatus according to an example of the present disclosure.

According to an example, a vehicle control apparatus (e.g., a vehicle control apparatus 100 of FIG. 1) may identify a lane in which a host vehicle 701 is traveling and may identify at least one other vehicle (711, 712, and 713) which is traveling in an adjacent lane adjacent to the lane.

For example, the vehicle control apparatus may identify at least one candidate area (751 and 752), based on a front safety distance and a rear safety distance for each of the at least one other vehicle (711, 712, and 713) in the adjacent lane.

For example, the vehicle control apparatus may control the host vehicle 701 to a target area identified according to an example of FIGS. 6A to 6D based on a user input, thus performing lane change control.

For example, the vehicle control apparatus may display the second GUI 752 corresponding to the target area on a display. At this time, the vehicle control apparatus may display guide information 799, about one point of the target area, which is expected to be reached if the host vehicle 701 makes a lane change to the target area, together.

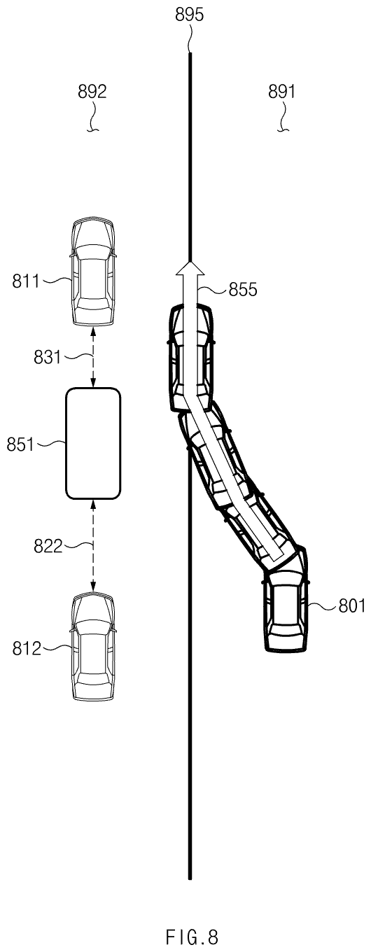

FIG. 8 shows an example of an operation of making a lane change in a vehicle control apparatus according to an example of the present disclosure.

According to an example, a vehicle control apparatus (e.g., a vehicle control apparatus 100 of FIG. 1) may identify a lane 891 in which a host vehicle 801 is traveling and may identify at least one other vehicle (811 and 812) which is traveling in an adjacent lane adjacent to the lane 891.

For example, the vehicle control apparatus may identify a target area for a lane change among at least one candidate area, based on a user input, and may control the host vehicle 801 from the lane 891 to the target area for the lane change in an adjacent lane 892. As an example, the vehicle control apparatus may control the host vehicle 801 along a specified lane change path.

For example, the vehicle control apparatus may identify the remaining space, except for areas corresponding to a first rear safety distance 831 and a second front safety distance 822, in an area between the first other vehicle 811 and the second other vehicle 812 as a target area for a lane change. The vehicle control apparatus may display a target GUI 851 corresponding to the target area on its display.

For example, the vehicle control apparatus may continuously monitor a change in size of the target area (or size of the target GUI 851), while making a lane change. The target area may change in size depending on a change in behaviors of the first other vehicle 811, the second other vehicle 812, and the host vehicle 801.

As an example, if the target area decreases in size while controlling the host vehicle 801 to the target area, the vehicle control apparatus may decrease a heading of the host vehicle 801 and may perform biased driving control toward the adjacent lane 892. The vehicle control apparatus may perform, for example, biased driving control based on a biased driving path. For biased driving, the host vehicle 801 may travel along a line 895 between the lane 891 and the adjacent lane 892.

To perform a biased driving, the vehicle control apparatus may control a vehicle to drive in a lane by maintaining a lateral distance between the position of the center of the vehicle and the center of the lane. For example, the vehicle control apparatus may control the vehicle to stay in the lane but not in the center of the lane.

The vehicle control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the vehicle control apparatus may bias the lateral distance to keep a safer gap from adjacent vehicles, considering factors such as the vehicle's speed, road conditions, and/or the presence of obstacles, etc.

As an example, if the size of the target area is continuously reduced or maintained during a predefined threshold time, the vehicle control apparatus may perform return control for the host vehicle 801 to return to the lane 891.

As an example, if the target area increases in size during the predefined threshold time, the vehicle control apparatus may control the host vehicle 801 to enter the target area, thus completing the lane change.

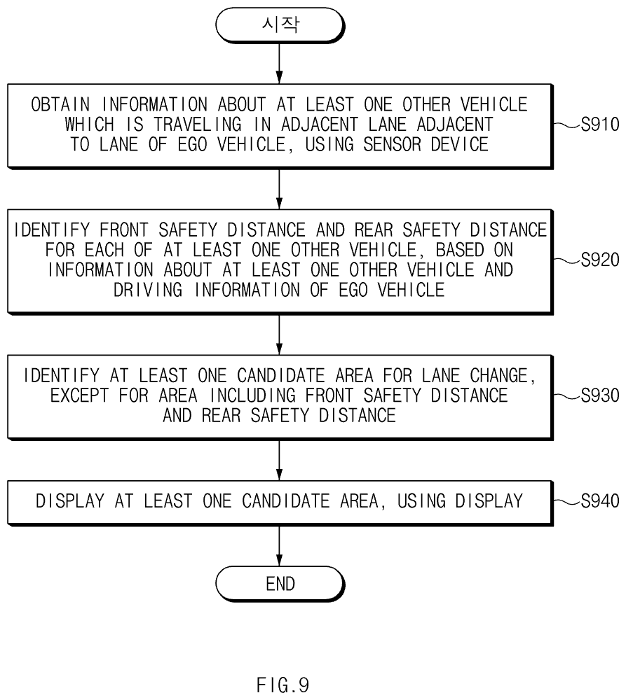

FIG. 9 shows an example of a vehicle control method according to an example of the present disclosure.

According to an example, a vehicle control apparatus (e.g., a vehicle control apparatus 100 of FIG. 1) may perform operations disclosed in FIG. 9. For example, at least some of components (e.g., a sensor 110, a display 120, a memory 130, and/or a controller 140 of FIG. 1) included in the vehicle control apparatus may be configured to perform operations of FIG. 9. One, some, or all steps of FIG. 9, or portions thereof, may be performed by one or more other circuits. One or some, steps of FIG. 9 may be omitted, performed in other orders, and/or otherwise modified, and/or one or more additional steps may be added.

Operations in S910 to S940 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 9, may be briefly described or omitted.

According to an example, in S910, the vehicle control apparatus may obtain information about at least one other vehicle which is traveling in an adjacent lane adjacent to a lane of a host vehicle, using its sensor.

According to an example, example, in S920, the vehicle control apparatus may identify a front safety distance and a rear safety distance for each of the at least one other vehicle, based on the information about the at least one other vehicle and driving information of the host vehicle.

According to an example, in S930, the vehicle control apparatus may identify at least one candidate area for a lane change, except for an area including the front safety distance and the rear safety distance.

According to an example, in S940, the vehicle control apparatus may display the at least one candidate area, using its display.

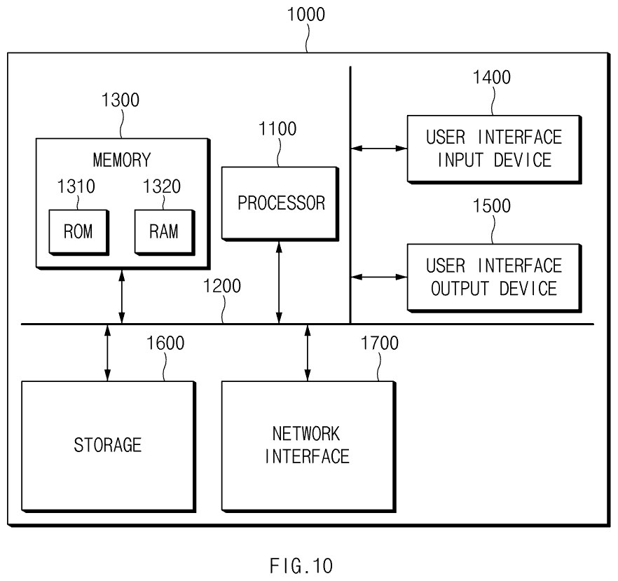

FIG. 10 shows an example of a computing system about a vehicle control apparatus or a vehicle control method according to an example of the present disclosure.

Referring to FIG. 10, a computing system 1000 about the vehicle control apparatus or the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The present disclosure has been made to solve the above-mentioned problems occurring in the prior art while advantages achieved by the prior art are maintained intact.

An example of the present disclosure provides a vehicle control apparatus for identifying at least one candidate area for a lane change, with regard to driving information of each of at least one other vehicle in an adjacent lane, and providing a user with the identified information by means of a display, such that it is possible for the user to intuitively and conveniently select an area for the lane change, and a method thereof.

Another example of the present disclosure provides a vehicle control apparatus for continuously providing a user with a driving state of a host vehicle, while making a lane change for the host vehicle, to provide the user with a driving experience with high reliability and a method thereof.

Another example of the present disclosure provides a vehicle control apparatus for displaying at least one candidate area displayed based on a behavior of the at least one other vehicle and further considering a size of a target area selected from the user, when making a lane change to the target area, to determine whether to complete the lane change or return to the lane to more stably and adaptively perform driving control and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a sensor, a display, a memory storing at least one instruction, and a controller operatively connected with the sensor, the display, and the memory. For example, the at least one instruction may be configured to, if executed by the controller, cause the vehicle control apparatus to obtain information about at least one other vehicle which is traveling in an adjacent lane adjacent to a lane of an host vehicle, using the sensor, identify a front safety distance and a rear safety distance for each of the at least one other vehicle, based on the information about the at least one other vehicle and driving information of the host vehicle, identify at least one candidate area in the adjacent lane for a lane change, except for an area including the front safety distance and the rear safety distance, and display the at least one candidate area, using the display.

According to an example, the at least one instruction may be configured to, if executed by the controller, cause the vehicle control apparatus to determine whether it is possible for the host vehicle to overtake a first other vehicle which is traveling in front of the host vehicle among the at least one other vehicle by a specified distance or more within a first time, using a driving speed of the first other vehicle, acceleration of the first other vehicle, and the driving information of the host vehicle, using the sensor, and identify a predefined preceding vehicle front safety distance as a first front safety distance for the first other vehicle, if it is determined that it is possible for the host vehicle to overtake the first other vehicle by the specified distance or more within the first time.

According to an example, the at least one instruction may be configured to, if executed by the controller, cause the vehicle control apparatus to determine whether it is possible for the host vehicle to overtake a first other vehicle which is traveling in front of the host vehicle among the at least one other vehicle by a specified distance or more within a first time, using a driving speed of the first other vehicle, acceleration of the first other vehicle, and the driving information of the host vehicle, determine that it is impossible to make the lane change to an area in front of the first other vehicle, if it is determined that it is impossible for the host vehicle to overtake the first other vehicle by the specified distance or more within the first time, and identify that there is no the at least one candidate area in the area in front of the first other vehicle.

According to an example, the at least one instruction may be configured to, if executed by the controller, cause the vehicle control apparatus to identify a driving speed of a second other vehicle which is traveling behind the host vehicle among the at least one other vehicle and identify a second front safety distance for the second other vehicle, using the driving speed of the second other vehicle, a driving speed of the host vehicle, a threshold response time, a margin time, and required deceleration and acceleration for the second other vehicle, if the driving speed of the second other vehicle is greater than the driving speed of the host vehicle.

According to an example, the second front safety distance may be identified as being proportional to the driving speed of the second other vehicle, the threshold response time, and the margin time and being inversely proportional to the required deceleration and acceleration.

According to an example, the at least one instruction may be configured to, if executed by the controller, cause the vehicle control apparatus to identify a driving speed of a second other vehicle which is traveling behind the host vehicle among the at least one other vehicle and identify a predefined following vehicle front safety distance as a second front safety distance for the second other vehicle, if the driving speed of the second other vehicle is smaller than a driving speed of the host vehicle.

According to an example, the at least one instruction may be configured to, if executed by the controller, cause the vehicle control apparatus to identify the rear safety distance for each of the at least one other vehicle, using a driving speed of the host vehicle, a margin time, or a margin distance, or any combination thereof.

According to an example, the at least one instruction may be configured to, if executed by the controller, cause the vehicle control apparatus to identify a first rear safety distance of a first other vehicle which is traveling in front of the host vehicle on the adjacent lane among the at least one other vehicle and a second front safety distance of a second other vehicle which is traveling behind the host vehicle and identify an area between the first other vehicle and the second other vehicle, except for areas respectively corresponding to the first rear safety distance and the second front safety distance, as the at least one candidate area.

According to an example, the at least one instruction may be configured to, if executed by the controller, cause the vehicle control apparatus to identify a first front safety distance of a first other vehicle which is traveling in front of the host vehicle on the adjacent lane among the at least one other vehicle and a third rear safety distance of a third other vehicle which is traveling in front of the first other vehicle and identify an area between the first other vehicle and the third other vehicle, except for areas respectively corresponding to the first front safety distance and the third rear safety distance, as the at least one candidate area.

According to an example, the vehicle control apparatus may further include an input device. For example, the at least one instruction may be configured to, if executed by the controller, cause the vehicle control apparatus to display a first graphic user interface (GUI) and a second GUI respectively corresponding to a first candidate area and a second candidate area among the at least one candidate area based on a first form, using the display and, if receiving a user input about the lane change to the adjacent lane via the input device, while the user input is maintained, display the first GUI based on a second form distinguished from the first form and display the second GUI based on the first form, during a first period, display the first GUI based on the first form and display the second GUI based on the second form, during a second period, after the first period elapses, and display the first GUI based on the second form and display the second GUI based on the first form, during a third period, after the second period elapses.

According to an example, the at least one instruction may be configured to, if executed by the controller, cause the vehicle control apparatus to control the host vehicle to an area corresponding to a GUI displayed in the second form at a time point when the user input is ended among the at least one candidate area to make the lane change, if the user input is ended.

According to an example, the at least one instruction may be configured to, if executed by the controller, cause the vehicle control apparatus to identify a target area for the lane change among the at least one candidate area, based on a user input and display guide information about one point of the target area, the one point being expected to be reached if the host vehicle makes the lane change, using the display.

According to an example, the at least one instruction may be configured to, if executed by the controller, cause the vehicle control apparatus to identify a target area for the lane change among the at least one candidate area, based on a user input, control the host vehicle to the target area for the lane change, and decrease a heading of the host vehicle and perform biased driving control toward the adjacent lane, if the target area decreases in size while controlling the host vehicle to the target area.

According to an example, the at least one instruction may be configured to, if executed by the controller, cause the vehicle control apparatus to perform return control causing the host vehicle to return to the lane, if the target area is continuously reduced or maintained in size during a predefined threshold time.

According to an example, the at least one instruction may be configured to, if executed by the controller, cause the vehicle control apparatus to control the host vehicle to enter the target area to complete the lane change, if the target area increases in size during a predefined threshold time.

According to another example of the present disclosure, a vehicle control method may include obtaining, by a controller, information about at least one other vehicle which is traveling in an adjacent lane adjacent to a lane of an host vehicle, using a sensor, identifying, by the controller, a front safety distance and a rear safety distance for each of the at least one other vehicle, based on the information about the at least one other vehicle and driving information of the host vehicle, identifying, by the controller, at least one candidate area in the adjacent lane for a lane change, except for an area including the front safety distance and the rear safety distance, and displaying, by the controller, the at least one candidate area, using a display.

According to an example, the vehicle control method may further include determining, by the controller, whether it is possible for the host vehicle to overtake a first other vehicle which is traveling in front of the host vehicle among the at least one other vehicle by a specified distance or more within a first time, using a driving speed of the first other vehicle, acceleration of the first other vehicle, and the driving information of the host vehicle, using the sensor, and identifying, by the controller, a predefined preceding vehicle front safety distance as a first front safety distance for the first other vehicle, if it is determined that it is possible for the host vehicle to overtake the first other vehicle by the specified distance or more within the first time.

According to an example, the vehicle control method may further include determining, by the controller, whether it is possible for the host vehicle to overtake a first other vehicle which is traveling in front of the host vehicle among the at least one other vehicle by a specified distance or more within a first time, using a driving speed of the first other vehicle, acceleration of the first other vehicle, and the driving information of the host vehicle, determining, by the controller, that it is impossible to make the lane change to an area in front of the first other vehicle, if it is determined that it is impossible for the host vehicle to overtake the first other vehicle by the specified distance or more within the first time, and identifying, by the controller, that there is no the at least one candidate area in the area in front of the first other vehicle.

According to an example, the vehicle control method may further include identifying, by the controller, a driving speed of a second other vehicle which is traveling behind the host vehicle among the at least one other vehicle and identifying, by the controller, a second front safety distance for the second other vehicle, using the driving speed of the second other vehicle, a driving speed of the host vehicle, a threshold response time, a margin time, and required deceleration and acceleration for the second other vehicle, if the driving speed of the second other vehicle is greater than the driving speed of the host vehicle.

According to an example, the vehicle control method may further include identifying, by the controller, a driving speed of a second other vehicle which is traveling behind the host vehicle among the at least one other vehicle and identifying, by the controller, a predefined following vehicle front safety distance as a second front safety distance for the second other vehicle, if the driving speed of the second other vehicle is smaller than a driving speed of the host vehicle.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the vehicle control apparatus and the method thereof according to an example of the present disclosure.

Examples of the present disclosure may provide the vehicle control apparatus for identifying at least one candidate area for a lane change, with regard to driving information of each of at least one other vehicle in an adjacent lane, and providing the user with the identified information by means of a display, such that it is possible for the user to intuitively and conveniently select an area for the lane change.

Examples of the present disclosure may continuously provide the user with a driving state of a host vehicle, while making a lane change for the host vehicle, thus providing the user with a driving experience with high reliability.

Examples of the present disclosure may display at least one candidate area displayed based on a behavior of the at least one other vehicle and may further consider a size of a target area selected from the user, when making a lane change to the target area, to determine whether to complete the lane change or return to the lane, thus more stably and adaptively performing driving control.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for controlling autonomous driving of a vehicle, the apparatus comprising:
a sensor;
a display;
a memory storing at least one instruction; and
a processor operatively coupled to the sensor, the display, and the memory,
wherein the at least one instruction is configured to, when executed by the processor, cause the apparatus to:
obtain, based on sensing information received from the sensor, information about at least one other vehicle which is traveling in a second lane adjacent to a first lane in which the vehicle is travelling;
determine, based on the information about the at least one other vehicle and driving information of the vehicle, a front safety distance for each of the at least one other vehicle and a rear safety distance for each of the at least one other vehicle;
determine at least one candidate area in the second lane for a lane change, wherein the at least one candidate area excludes areas within the front safety distance and the rear safety distance; and
display, via the display, the at least one candidate area.

2. The apparatus of claim 1, wherein the at least one instruction is configured to, when executed by the processor, cause the apparatus to:
determine, based on sensing information received from the sensor, at least one characteristic of the at least one other vehicle, wherein the at least one characteristic comprises at least one of a speed of the at least one other vehicle or acceleration of the at least one other vehicle;
determine whether the vehicle is able overtake a first other vehicle, among the at least one other vehicle, traveling in front of the vehicle by at least a specified distance within a first time, wherein whether the vehicle is able to overtake the first other vehicle is determined based on a speed of the first other vehicle, acceleration of the first other vehicle, and the driving information of the vehicle; and
determine, based on a determination that the vehicle is able to overtake the first other vehicle by the at least the specified distance within the first time, a first front safety distance for the first other vehicle.

3. The apparatus of claim 1, wherein the at least one instruction is configured to, when executed by the processor, cause the apparatus to:
determine, based on a speed of a first other vehicle, acceleration of the first other vehicle, and the driving information of the vehicle, whether the vehicle is able to overtake the first other vehicle, among the at least one other vehicle, traveling in front of the vehicle by at least a specified distance within a first time;
determine, based on a determination that the vehicle is unable to overtake the first other vehicle by the at least the specified distance within the first time, not to make the lane change to an area in front of the first other vehicle; and
determine that no candidate area for a lane change is available in an area in front of the first other vehicle.

4. The apparatus of claim 1, wherein the at least one instruction is configured to, when executed by the processor, cause the apparatus to:
determine a speed of a second other vehicle, among the at least one other vehicle, traveling behind the vehicle; and
determine a second front safety distance for the second other vehicle, wherein the second front safety distance is determined based on the speed of the second other vehicle being greater than a speed of the vehicle, a threshold response time, a margin time, and required deceleration and acceleration for the second other vehicle, and wherein the second front safety distance is a predefined minimum distance to be maintained between the vehicle and the second other vehicle.

5. The apparatus of claim 4, wherein the second front safety distance is:
proportional to the speed of the second other vehicle, the threshold response time, and the margin time, and
inversely proportional to the required deceleration and acceleration.

6. The apparatus of claim 1, wherein the at least one instruction is configured to, when executed by the processor, cause the apparatus to:
determine a speed of a second other vehicle, among the at least one other vehicle, traveling behind the vehicle; and
determine, based on the speed of the second other vehicle being smaller than a speed of the vehicle, a second front safety distance for the second other vehicle, wherein the second front safety distance is a predefined minimum distance to be maintained between the vehicle and the second other vehicle.

7. The apparatus of claim 1, wherein the at least one instruction is configured to, when executed by the processor, cause the apparatus to:
determine the rear safety distance for each of the at least one other vehicle, based on a speed of the vehicle, a margin time, or a margin distance.

8. The apparatus of claim 1, wherein the at least one instruction is configured to, when executed by the processor, cause the apparatus to:
determine a first rear safety distance of a first other vehicle, among the at least one other vehicle, traveling in front of the vehicle and in the second lane;
determine a second front safety distance of a second other vehicle traveling behind the vehicle; and
determine an area between the first other vehicle and the second other vehicle as the at least one candidate area, wherein the determined area excludes areas within the first rear safety distance and the second front safety distance.

9. The apparatus of claim 1, wherein the at least one instruction is configured to, when executed by the processor, cause the apparatus to:
determine a first front safety distance of a first other vehicle, among the at least one other vehicle, traveling in front of the vehicle and in the second;
determine a third rear safety distance of a third other vehicle traveling in front of the first other vehicle; and
determine an area between the first other vehicle and the third other vehicle as the at least one candidate area, wherein the determined area excludes areas within the first front safety distance and the third rear safety distance.

10. The apparatus of claim 1, further comprising:
an input device,
wherein the at least one instruction is configured to, when executed by the processor, cause the apparatus to:
display, via the display, a first graphic user interface (GUI) and a second GUI based on a first form, wherein the first GUI is associated with a first candidate area among the at least one candidate area and the second GUI is associated with a second candidate area among the at least one candidate area; and
based on receiving, via the input device, a user input about the lane change to the second lane:
during a first period, display, based on a second form different from the first form, the first GUI and display, based on the first form, the second GUI;
during a second period, after the first period elapses, display, based on the first form, the first GUI, and display, based on the second form, the second GUI; and
during a third period, after the second period elapses, display, based on the second form, the first GUI, and display, based on the first form, the second GUI.

11. The apparatus of claim 10, wherein the at least one instruction is configured to, when executed by the processor, cause the apparatus to:
control the vehicle to move into an area, among the at least one candidate area, to make the lane change, wherein the area to make the lane change corresponds to a GUI displayed in the second form at a time point the user input.

12. The apparatus of claim 1, wherein the at least one instruction is configured to, when executed by the processor, cause the apparatus to:
determine, based on a user input, a target area, among the at least one candidate area, for the lane change; and
display, via the display, guide information about one point of the target area, wherein the one point is expected to be reached based on the vehicle making the lane change.

13. The apparatus of claim 1, wherein the at least one instruction is configured to, when executed by the processor, cause the apparatus to:
determine, based on a user input, a target area, among the at least one candidate area, for the lane change;
control the vehicle to move into the target area for the lane change; and
decrease, based on the target area decreasing in size while controlling the vehicle to move into the target area, a heading of the vehicle and perform biased driving control toward the second lane.

14. The apparatus of claim 13, wherein the at least one instruction is configured to, when executed by the processor, cause the apparatus to:
perform, based on the target area being continuously reduced or maintained in size during a predefined threshold time, return control causing the vehicle to return to the first lane.

15. The apparatus of claim 13, wherein the at least one instruction is configured to, when executed by the processor, cause the apparatus to:
control, based on the target area increasing in size during a predefined threshold time, the vehicle to enter the target area to complete the lane change.

16. A method performed by an apparatus for controlling autonomous driving of a vehicle, the method comprising:
obtaining, based on sensing information received from a sensor, information about at least one other vehicle which is traveling in a second lane adjacent to a first lane in which the vehicle is travelling;
determining, based on the information about the at least one other vehicle and driving information of the vehicle, a front safety distance for each of the at least one other vehicle and a rear safety distance for each of the at least one other vehicle;
determining at least one candidate area in the second lane for a lane change, wherein the at least one candidate area excludes areas within the front safety distance and the rear safety distance; and
displaying, via a display, the at least one candidate area.

17. The method of claim 16, further comprising:
determining, based on sensing information received from the sensor, at least one characteristic of the at least one other vehicle, wherein the at least one characteristic comprises at least one of a speed of the at least one other vehicle or acceleration of the at least one other vehicle;
determining, whether the vehicle is able to overtake a first other vehicle, among the at least one other vehicle, traveling in front of the vehicle by at least a specified distance within a first time, wherein whether the vehicle is able to overtake the first other vehicle is determined based on a speed of the first other vehicle, acceleration of the first other vehicle, and the driving information of the vehicle; and
determining, based on a determination that the vehicle is able to overtake the first other vehicle by the at least the specified distance within the first time, a first front safety distance for the first other vehicle.

18. The method of claim 16, further comprising:
determining, based on a speed of a first other vehicle, acceleration of the first other vehicle, and the driving information of the vehicle, whether the vehicle is able to overtake the first other vehicle, among the at least one other vehicle, traveling in front of the vehicle by at least a specified distance within a first time;
determining, based on a determination that the vehicle is unable to overtake the first other vehicle by the at least the specified distance within the first time, not to make the lane change to an area in front of the first other vehicle; and
determining that no candidate area for a lane change is available in an area in front of the first other vehicle.

19. The method of claim 16, further comprising:
determining a speed of a second other vehicle, among the at least one other vehicle, traveling behind the vehicle; and
determining a second front safety distance for the second other vehicle, wherein the second front safety distance is determined based on the speed of the second other vehicle being great than a speed of the vehicle, a threshold response time, a margin time, and required deceleration and acceleration for the second other vehicle, and wherein the second front safety distance is a predefined minimum distance to be maintained between the vehicle and the second other vehicle.

20. The method of claim 16, further comprising:
determining a speed of a second other vehicle, among the at least one other vehicle, traveling behind the vehicle; and
determining, based on the speed of the second other vehicle being smaller than a speed of the vehicle, a second front safety distance for the second other vehicle, wherein the second front safety distance is a predefined minimum distance to be maintained between the vehicle and the second other vehicle.
